(19) United States
(12) Patent Application Publication
(10) Pub. No.: US 2003/0189647 A1
(43) Pub. Date: Oct. 9, 2003

(54) Method of taking pictures

(76) Inventor: Beng Hong Alex Kang, Singapore (SG)

Correspondence Address: HEWLETT-PACKARD COMPANY, Intellectual Property Administration, P.O. Box 272400, Fort Collins, CO, 80527-2400, US

(21) Appl. No.: 10/170,771

(22) Filed: Jun. 13, 2002

(30) Foreign Application Priority Data
Apr. 5, 2002 (SG) 200202044-4

(51) Int. Cl. H04N 5/225

(52) U.S. Cl. 348/207.99

(57) ABSTRACT

An improved method of taking pictures to capture a precise picture composition is provided. The invention is implemented in a digital camera as an operation mode or feature. When this mode is activated, the camera captures a series of images including a precise picture composition desired by the user. From the series of images describing a chronological sequence of events, the user can select a best-timed shot.

### BACKGROUND OF THE INVENTION

1. Field of the Invention

The present invention relates to digital cameras. More particularly, it relates to an improved method of taking pictures.

2. Description of Background Information

The advent of digital cameras has brought photography into a new era. Unlike conventional Single-Lens-Reflex and snapshot cameras, digital cameras do not require films and film processing. An image is captured and instantly viewable. Users do not have to worry about film processing costs and film damage.

Regardless whether a digital camera or a conventional camera is used, a common problem faced by camera users is taking imperfect pictures due to ill-timed depression of the shutter button. This situation arises because when a camera user has composed a picture, he depresses a shutter button but the composition of the picture may have changed unfavorably. For example, when a camera user wants to take a snapshot of a toddler smiling, he may need to coax a smile from the toddler. Finally, when the picture is composed, the user presses the shutter button. However, the toddler's smile has turned into a frown, resulting in an imperfect picture. The camera user will then have to coax the toddler again to recompose the picture. Even then, the picture may still be imperfect since the composition of the picture may again unpredictably change.

Another common problem relates to taking pictures of a moving object, for example, a dolphin leaping out of water. A camera user usually waits till the moving object is in a desired position before pressing a shutter button to capture the image. Unfortunately, there is usually a lag (i.e. reaction time) between the time the user sees a desired composition and the time he presses the button. If the user were taking pictures of a moving object, the composition of the captured image will be different from the desired composition. This situation can be illustrated by FIG. 1, where a user-desired composition is labeled by 119. However, due to the lag and the speed of the moving object, the image eventually captured is labeled by 120, where the object has assumed another position.

One solution for taking pictures of a moving object, which is provided in existing digital cameras, is known as “burst mode” or “continuous mode.” The “burst mode” allows the camera to take pictures in quick succession after a depression on the shutter button. This solution allows a user to capture a sequence of pictures when the shutter button is kept fully depressed.

While “burst mode” is advantageous for taking pictures of moving objects, it allows successive capture of images only after the shutter button is pressed, whereas many imperfect pictures are due to lag in button depression after a picture is composed. To overcome this shortcoming of “burst mode,” a user can depress the shutter button prematurely, i.e., before the desired picture is composed, for capturing a sequence of images. However, premature depression of the shutter button is not instinctive to camera users. They usually cannot decide on a precise moment to depress the shutter button for capturing a sequence of images. If the desired picture composition does not eventually appear in the viewfinder, there may be storage wastage. Incidentally, many users also do not associate “burst mode” with taking pictures of relatively still objects.

Accordingly, there is a need for an improved method of taking pictures to capture a precise picture composition with a first shutter button depression to create an ideal user experience.

### SUMMARY OF THE INVENTION

The present invention provides a method of taking pictures to capture a precise picture composition by a first shutter button depression to create an ideal user experience. The invention does this by capturing a series of images, including a pre-capture image taken prior to a shutter button depression, an actual shot and a post-capture image taken after the actual shot.

A function mode which implements the present invention in digital cameras is referred to as a “golden moment” mode. The “golden moment” mode can be activated by a user-action in various ways, such as, pressing a button for selecting an operation mode, half-depressing the shutter button and resting a finger on the shutter button. When the “golden moment” mode is activated, the camera starts to capture images at a predetermined capture rate. The images are then stored in a pre-capture First-In-First-Out (FIFO) buffer. The size of the pre-capture buffer is pre-defined for storing a predetermined number of images. When the number of images stored in the buffer exceeds the predetermined number, the contents of the buffer are refreshed, i.e., the images are discarded in a first-in-first-out manner and the new images are stored in the buffer. When the user finally depresses the shutter button fully, the contents of the pre-capture buffer are preserved, where there is no discard or addition of images in the pre-capture buffer. After the camera captures an actual shot 120 triggered by a full depression of the shutter button, the camera continues to capture a predetermined number of images which are stored in a post-capture buffer. Thereafter, the contents of the pre-capture buffer, the actual shot 120 and the post-capture buffer are organized for viewing and storing. The pre-capture buffer and post-capture buffer are then emptied in preparation for a next shot (or shutter button depression).

By capturing images prior to a user depressing the shutter button, the present invention solves a common problem of imperfect picture composition due to ill-timed shutter button depression.

### BRIEF DESCRIPTION OF THE DRAWINGS

The present invention will be described with reference to the accompanying drawings, in which:

FIG. 1 describes picture compositions of a moving object in chronological sequence.

FIG. 2 is a flowchart illustrating a first embodiment of the present invention.

FIG. 3 describes the contents of a pre-capture FIFO buffer at a first time window.

FIG. 4 describes the contents of a pre-capture FIFO buffer at a second time window.

FIG. 5 describes the contents of a pre-capture FIFO buffer at a third time window.

### DETAILED DESCRIPTION

The present invention is suited for implementing in a digital camera. For understanding the present invention, only relevant parts of the digital camera will be briefly described. A typical standalone digital camera has a body comprising a lens, an optical viewfinder, a Liquid Crystal Display (LCD), buttons, dials, battery compartment, microprocessor, and the like. The typical digital camera may also comprise a memory module, a compartment for receiving a memory media, and a connection port for facilitating data transfer to a computer. According to individual operation modes of a digital camera, a user may compose a picture through the optical viewfinder or through the LCD or through both. The present invention is also applicable to a digital camera that is used as an accessory. Such digital cameras may be interfaced with various devices, such as a Personal Digital Assistant (PDA), a notebook, a printer and a mobile telephone. Interfacing means includes a physical connection such as a Compact Flash slot, or a wireless connection such as infra red and Bluetooth. The digital camera may also be incorporated in the various devices.

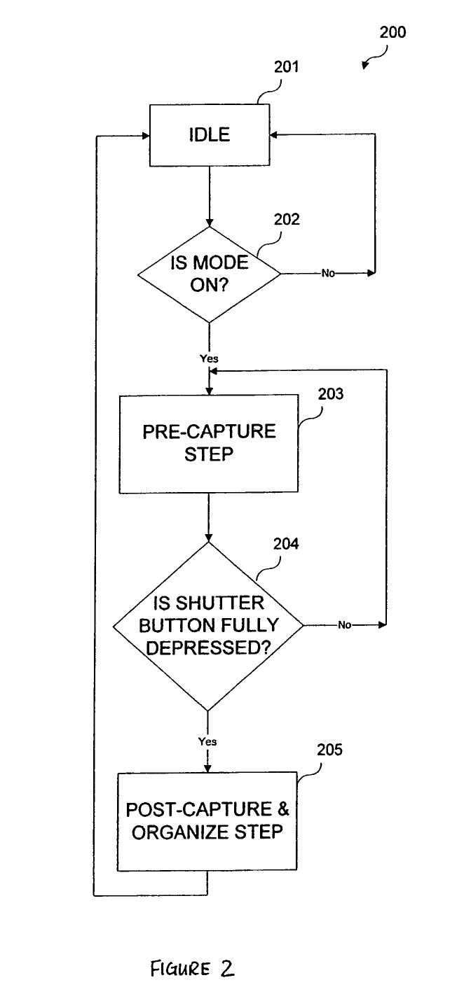

FIG. 2 shows a flowchart sequence 200 for understanding a first embodiment of the present invention. The sequence 200 begins with a digital camera in an IDLE state in step 201. In this step 201, the digital camera may be switched on and awaiting a user to initiate an action. When the “golden moment” mode is activated, the IDLE step 201 proceeds through IS MODE ON? step 202 and then to a PRE-CAPTURE STEP 203. If the “golden moment” mode is not activated, the camera remains in the IDLE step 201.

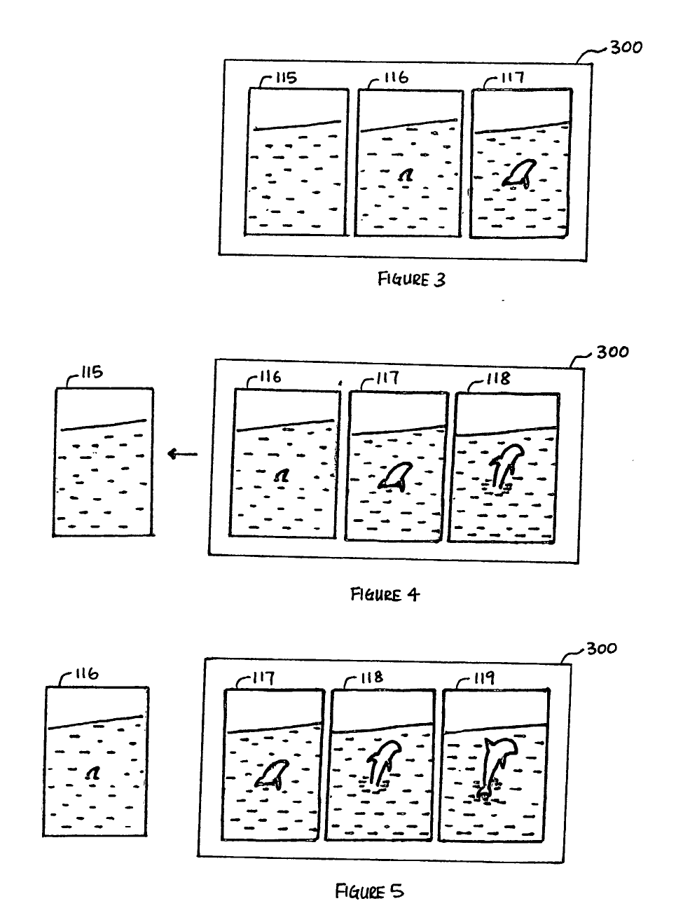

In the PRE-CAPTURE STEP 203, images are captured continually prior to a full shutter button depression and stored in a pre-capture First-In-First-Out (FIFO) buffer 300. The pre-capture FIFO buffer 300 is programmed to store a predetermined number of images, for example, N images. An empty pre-capture FIFO buffer 300 stores up to N images, beyond which the oldest image is discarded and a most recent image is received and stored. This concept is illustrated in FIGS. 3, 4 and 5.

Reference is now made to FIGS. 3, 4 and 5. Assuming the digital camera has a capture rate of four frames per second, the digital camera is able to capture an image every 0.25 second. The captured images are then stored in the pre-capture buffer 300. Assuming the pre-capture buffer 300 is a 0.75-second FIFO buffer, it can store up to 3 images. At the PRE-CAPTURE STEP 203 (of FIG. 2), the camera starts to capture images at a rate of four frames per seconds. Within the first 0.75 second, a first image 115, a second image 116 and a third image 117 are captured, which fill up the pre-capture buffer 300. At 1.00 second, a fourth image 118 is captured. Since the capacity of the buffer is full, the first image 115 is discarded to store the fourth image 118 in the buffer. At 1.25 second, the second image 116 is discarded to store a fifth image 119 in the buffer. This process of continually refreshing contents of the pre-capture buffer 300 goes on until the “golden moment” mode is deactivated or until the shutter button is fully depressed. If the “golden moment” mode is deactivated, the sequence returns to an IDLE step 202. The images in the pre-capture buffer 300 may then be discarded.

When a user fully depresses the shutter button to capture an image, the PRE-CAPTURE STEP 203 proceeds through an IS SHUTTER BUTTON FULLY DEPRESSED? step 204 to a POST-CAPTURE & ORGANIZE STEP 205.

In the POST-CAPTURE & ORGANIZE STEP 205, the contents of the pre-capture FIFO buffer 300 are preserved. No image is discarded from or added to the pre-capture buffer 300. However, the camera continues to capture a predetermined number of images after the actual shot 120 is taken. These post-capture images 130 are stored in a post-capture buffer. A user now has pre-capture images 110 taken before the shutter button depression, an actual shot 120 is taken when the shutter button is fully depressed, and post-capture images 130 taken after the depression of the shutter button.

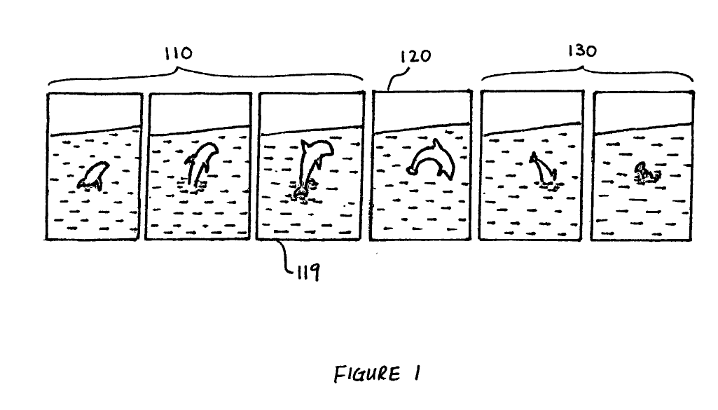

The pre-capture images 110, the actual shot 120 and post-capture images 130 describe a chronological sequence of events. These images are organized for viewing and/or storing. One method of organizing the images is to display the actual shot 120 captured when the shutter button is fully depressed. The pre-capture images 110 and post-capture images 130 may be arranged in sequential order as illustrated in FIG. 1, and viewed using scrolling functions provided for in a digital camera. Other methods of organizing the images for viewing as known in the art are also applicable with the present invention. The contents of the buffers may be transferred to another memory portion for storing with the actual shot 120. The contents of the buffers can then be emptied in preparation for a next shot. When the shutter button is released or after an actual shot 120 is taken, sequence 200 proceeds to the IDLE step 201 to wait for further user-action.

To illustrate the advantages of the present invention, reference is made to FIG. 1. A user composes a picture of an event featuring a moving object. When the object assumed a position in 119, the user decides that this is a desired composition and presses the shutter button to capture an image. By the time he fully depresses the shutter button, there has been a lag and another picture composition 120 is captured instead. Hence, with the present invention, a user is additionally able to capture images before and after a full shutter button depression to obtain a well-timed picture composition. The present invention is also advantageous when taking pictures of a relatively still object, where there may be unpredictable changes in the object or in the lighting conditions.

In a second embodiment of the present invention, no images are captured after the actual shot 120 is taken. It follows that a post-capture buffer will not be needed. In this embodiment, when the actual shot 120 is captured, the pre-capture images 110 and the actual shot 120 are organized for viewing and storing.

The present invention is also suited for use with the “burst mode” known in the art. Typically, when the “burst mode” and the “golden moment” modes are activated, the camera captures images continually at a predetermined capture rate as in the PRE-CAPTURE STEP 203 before a full shutter button depression for taking an actual shot. Subsequently, when the shutter button is fully depressed, the camera captures images continually as long as the button is kept fully depressed. When the shutter button is released, post-capture images 130 are then captured as described for POST-CAPTURE & ORGANIZE STEP 205. Where both “burst mode” and “golden moment” modes are activated, a user will have pre-capture images 110, a set of actual shots, and post-capture images 130. The pre-capture images 110 and post-capture images 130 are then organized with the actual shots for viewing and/or storing.

“Burst modes” of certain digital cameras may work differently. For example, with any single full depression of the shutter button, a predetermined number of shots are captured at a predetermined rate. Alternatively, successive pictures are taken as long as the shutter button is kept fully depressed. The present invention is also equally applicable with different implementation of the “burst mode”.

Activation of the “golden moment” mode can be initiated by several methods. A first method is pressing an assigned button or a combination of buttons assigned for activating the mode. To deactivate, a similar button or a combination of buttons needs to be pressed. A second method is activating the mode whenever a user half-depresses a shutter button. If a user half-depresses the shutter release button and releases the button without first fully depressing it, the “golden moment” mode is deactivated and contents in the pre-capture buffer 300 may be discarded. A third method is activating when a user rests his finger on the shutter button. A sensor may be installed to detect whether a user's finger's is resting on the shutter button. If the user lifts his finger without first fully depressing the shutter button, the “golden moment” mode is then deactivated and the contents in the pre-capture buffer may be discarded. Optionally, the “golden moment” mode may be activated using any of the above method in response to a user action (i.e. pressing an assigned button, resting a finger on the shutter button, or half-depressing the shutter button).

In a digital camera utilizing the second or the third method of activating the “golden moment” mode, the camera may provide a function for disabling the mode so that the mode does not activate when a user half-depresses or rests his finger on the shutter button.

In the foregoing, a full depression of the shutter button is described for capturing an image. The same may be replaced by equivalents, such as, remote control, voice-recognition activation, and the like.

The pre-capture 300 and post-capture buffers store images captured within a time window. For illustration purposes, T refers to the instant when a shutter button is fully depressed. T₁ refers to a time window prior to T, where images taken in this window are referred to as pre-capture images 120. T₂ refers to a time window after T, where images taken in this window are referred to as post-capture images 130. As an example, T₁ has a value of 1.5 seconds and T₂ has a value of 0.75 seconds. If the capture rate of the digital camera is four frames per second, for every full depression of the shutter button, a user will have six images stored as pre-capture images 110, one image for the actual shot 120 (when shutter button is fully depressed), and three images stored as post-capture images 130. Thus, the user can choose a best or most perfectly-timed picture from a total of ten images.

Although T₁ and T₂ may be defined as large values to capture as many images as possible, the values of T₁ and T₂ may be constrained by memory space available to a user. Furthermore, a user may have to sieve through more images when he is choosing his best shot.

The values of T₁, T₂ and capture rate are typically pre-defined by a camera manufacturer or designer. T₁ and T₂ may also be user-defined by allowing a user to select or input values. When T₁ or T₂ and/or capture rate is varied, the number of pre-capture images and/or post-capture images varies accordingly. In most cases of ill-timed pictures, the lag is usually about half a second after a desired picture is composed. Thus, the value of T1 and the capture rate may be defined to capture as many frames as possible during this half-second lag. Optionally, a user can specify not to capture the post-capture images 130 by setting T₂ to zero or disabling T₂.

In the POST-CAPTURE & ORGANIZE STEP 205, where the post-capture images 130 have been captured and stored in the post-capture buffer, the images are ready for a user's selection. A user can select his best picture after each shot, or he can select at a later time. When a user has selected his desired image, the unselected images may be discarded. The user can also select more than one image from each sequence taken from one full depression of the shutter button.

In the foregoing embodiments, a separate pre-capture buffer 300 and post-capture buffer are employed. However, it may be understood by a person skilled in the art that other equivalents are equally applicable. For example, the invention may employ one FIFO buffer. More particularly, in the PRE-CAPTURE STEP 203, the FIFO stores pre-capture images 110 and refreshes its contents as described earlier. When the shutter button is fully depressed and advances to a POST-CAPTURE & ORGANIZE STEP 205, the actual shot 120 and the post-capture images 130 are also stored in the same FIFO. Older pre-capture images are discarded; the actual shot 120 and the post-capture 130 images are stored in the FIFO buffer, thereby refreshing contents in a first-in-first-out manner. The refreshing process ceases when the pre-capture images 110, the actual shot 120 and the post-capture images 130 have been captured. The FIFO buffer may then be emptied, by transferring its contents to another memory portion, to prepare for a next shot.

As an illustration of the current implementation, the FIFO buffer has a predefined size of ten images, and it contains ten pre-capture images prior to a shutter button depression. When the shutter button is depressed, an actual shot is taken. Subsequently, post-capture images (for example, three images) are also taken. Since the FIFO buffer has a capacity of ten images, the older images are discarded and the new images are stored in the FIFO buffer. The FIFO buffer eventually contains six pre-capture images, one actual shot and three post-capture images. These images are then organized in a same manner described earlier.

What is claimed is:

1. A method of taking pictures with a digital camera, comprising the steps of:
activating a function mode for capturing at least one first image prior to activating a mechanism for capturing at least one second image; and
activating the mechanism for capturing the at least one second image.

2. The method according to claim 1 further comprises storing the at least one first image in a first buffer having a predetermined size; and
refreshing contents of the first buffer in a first-in-first-out manner.

3. The method according to claim 2, wherein refreshing contents of the first buffer in a first-in-first-out manner includes refreshing contents of the first buffer in a first-in-first-out manner until the step of activating the mechanism.

4. The method according to claim 1, wherein after activating the mechanism for capturing at least one second image, further comprises capturing at least one third image.

5. The method according to claim 4 further comprises storing the at least one first image in a first buffer having a predetermined size; and refreshing contents of the first buffer in a first-in-first-out manner.

6. The method according to claim 5, wherein refreshing contents of the first buffer in a first-in-first-out manner includes refreshing the contents of the first buffer in a first-in-first-out manner until the step of activating the mechanism.

7. The method according to claim 6 further comprises storing the at least one third image in a second buffer.

8. The method according to claim 5 further comprises storing the at least one second image and the at least one third image in the first buffer; and refreshing the contents of the first buffer in a first-in-first-out manner.

9. The method according to claim 8, wherein refreshing the contents of the first buffer in a first-in-first-out manner ceases when the at least one third image is captured.

10. A digital camera comprising:
a function mode which is activated for capturing at least one first image; and
a mechanism which is activated for capturing at least one second image wherein the at least one first image is captured prior to activating the mechanism.

11. The digital camera according to claim 10, wherein the at least one first image is stored in a first buffer having a predetermined size, and contents of the first buffer are refreshed in a first-in-first-out manner.

12. The digital camera according to claim 11, wherein the contents of the first buffer are refreshed in a first-in-first-out manner until the mechanism is activated.

13. The digital camera according to claim 10, wherein after the mechanism is activated for capturing the at least one second image, at least one third image is captured.

14. The digital camera according to claim 13, wherein the at least one first image is stored in a first buffer having a predetermined size, and contents of the first buffer are refreshed in a first-in-first-out manner.

15. The digital camera according to claim 14, wherein the contents of the first buffer are refreshed in a first-in-first-out manner until the mechanism is activated.

16. The digital camera according to claim 15, wherein the at least one third image is stored in a second buffer.

17. The digital camera according to claim 14, wherein the at least one second image and the at least one third image are stored in the first buffer, and contents of the first buffer are refreshed in a first-in-first-out manner.

18. The digital camera according to claim 17, wherein the contents of the first buffer cease to be refreshed when the at least one third image is captured.
